(19) United States
(12) Patent Application Publication
(10) Pub. No.: US 2007/0071263 A1
(43) Pub. Date: Mar. 29, 2007

(54) Individually adjustable hearing apparatus

(75) Inventor: Frank Beck, Spardorf (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AUDIOLOGISCHE TECHNIK GMBH

(21) Appl. No.: 11/527,208

(22) Filed: Sep. 26, 2006

(30) Foreign Application Priority Data
Sep. 26, 2005 (DE) 10 2005 045 899.8

(51) Int. Cl. H04R 25/00

(52) U.S. Cl. 381/315; 381/312

(57) ABSTRACT

The application possibilities of a hearing apparatus which can be worn on the head of a user, which allows the adjustment of the signal processing in the hearing apparatus to individual user specifications as well as to the individual hearing ability of the user, is to be improved. For this purpose, it is proposed to store a number of sets of control parameters, which significantly determine the signal processing in the hearing device, so-called user profiles in the hearing apparatus, between which a changeover can be made by activating a control element.

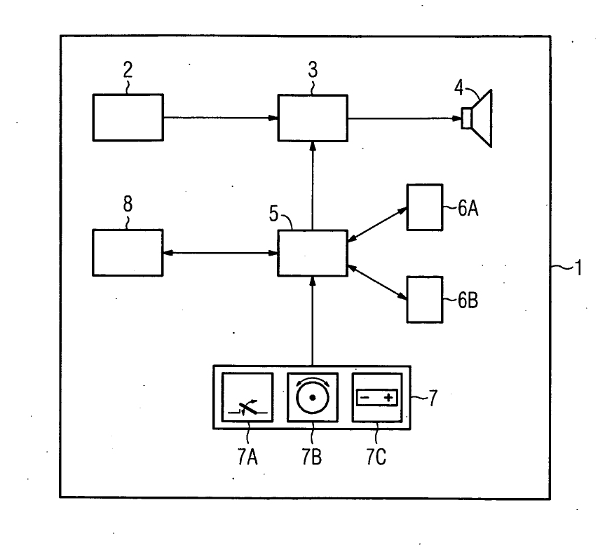

### CROSS REFERENCE TO RELATED APPLICATIONS

This application claims priority of German application No. 10 2005 045 899.8 filed Sep. 26, 2005, which is incorporated by reference herein in its entirety.

### FIELD OF THE INVENTION

The invention relates to a hearing apparatus which can be worn on the head of a user and can be connected to an audio-signal source, comprising an audio signal input facility, a signal processing facility for processing an incoming audio signal, at least one loudspeaker for converting the processed audio signal into an acoustic output signal and a control facility for adjusting the signal processing in the hearing apparatus according to a user profile which can be stored in the hearing apparatus.

### BACKGROUND OF THE INVENTION

Audio devices from the entertainment field (hifi systems etc) often enable the frequency response to be individually adjusted according to user specifications. The adjustment possibilities are mostly limited here to the rise or fall of specific frequency ranges, by an equalizer for instance, and/or to a different volume adjustment (balance control) with the use of several loudspeakers whilst playing back the acoustic output signal. The possibilities of an individual signal adjustment by means of the hearing apparatus are generally very restricted in the case of the signal playback by means of hearing apparatuses which can be worn on the head (headphones, head-sets etc.).

A training facility for hearing device wearers is known from EP 1 353 530 A1. Provision is made in this case for several audio training exercises to be stored in a database and an audio training exercise adjusted to the individual user to be implemented by means of the training facility.

An audio signal playback device is known from WO 2001/24576 A1, which features the possibility of implementing the hearing test in order to acquire an individual user profile of the user, whereby, to a certain degree, a hearing loss of the user can also be compensated for. In addition to the pure compensation of a hearing loss, further individual user inputs can also be implemented with the known audio playback device and can be stored in the individual user profile. In the audio signal playback device, the signal processing of an incoming audio signal takes place according to the user profile stored in the device.

The audio playback device can be designed as an individual device and can comprise headphones or a headset for instance.

The known hearing apparatus is disadvantageous in that when a user profile is used for signal processing purposes, said hearing apparatus is specially adjusted to a specific user.

### SUMMARY OF THE INVENTION

The object of the present invention is thus to design a hearing apparatus such that by exhausting its possibilities this can be used by several people.

This object is achieved with a hearing apparatus of the type mentioned at the start in that in the hearing apparatus, several profiles for the individual adjustment of the signal processing in the hearing apparatus to different users can be stored and activated.

The invention is advantageous in that by means of the signal processing of an audio signal incoming into the hearing apparatus by allowing for an individual user profile, an individual adjustment of the input signal to the hearing ability of the user, as well as to special user preferences is possible. The invention is further advantageous in that the possibility of storing and activating several individual user profiles in the device allows the hearing apparatus according to the invention to be used equally by several people, for instance partners, family members etc, without extensive new adjustments being necessary in each instance for this purpose. As a number of individual user profiles can be stored in the hearing apparatus for several users, each user of the hearing apparatus need only make adjustments to their individual preferences and requirements once and can then only activate the user profile stored for him/her at any further use.

With one embodiment of the invention, a hearing text device for acquiring the individual hearing ability of a user and for generating corresponding control parameters for controlling the signal processing as a function of the detected hearing ability is integrated in the hearing apparatus. A hearing test can be activated for instance by actuating a corresponding control element or in the case of an extremely user-friendly embodiment of the hearing apparatus also by means of voice entries. By way of example and similar to a hearing test, the user then obtains tones at different frequencies each with an increasing level, and once the user hears the respective tone, he/she confirms this by a keystroke, voice control or any other suitable manner. The hearing threshold of an individual user is determined for different frequencies. The hearing apparatus calculates control parameters for controlling the signal processing in the hearing apparatus from this test in order to adjust the signal processing to the individual hearing ability of the user and in particular to compensate for a hardness of hearing. A hearing apparatus adjusted individually in this manner allows the user to hear an acoustic signal, a piece of music for instance, as if his/her ear would exhibit an “ideal frequency response”. Deviations from this “ideal frequency response” are, as far as possible, compensated for by the hearing apparatus.

A set of specific control parameters for controlling the signal processing in the hearing apparatus and tailored to an individual user is referred to as an individual user profile. In order to determine an individual user profile, aside from determining the hearing threshold, further tests can also be implemented, e.g. for determining the discomfort threshold as a function of the signal frequency.

In addition to making adjustments to the individual hearing ability of a user, individual user specifications can again also be suggested in the control parameters combined in a user profile, said user specifications being independent of the respective hearing ability. By way of example, a user can directly store a preferred height or depth increase in his/her individual user profile. The signal adjustments associated herewith during the processing of an input signal are then constantly automatically effective, provided the relevant user profile is activated.

The changeover between different user profiles is preferably carried out by a control element attached to the hearing apparatus, e.g. a pushbutton key for instance. The hearing apparatus preferably also comprises display means so that it is immediately visible to every user which user profile is currently activated. With a particularly simple embodiment, the display is carried out by the control element in order to change over between different user profiles, e.g. by means of a pointer attached to a rotary switch, said pointer pointing at a number assigned individually to each user profile. Any other display means are however also possible, e.g. electronic numerical displays, voice output when the hearing apparatus is switched on etc.

The hearing apparatus according to the invention is preferably configured as headphones, which can be connected to a plurality of current audio playback devices (radio, television, hifi systems etc.). In this way, the connection to the respective audio device can be carried out wirelessly or in a wired manner. Furthermore, the hearing device according to the invention can also be an element of a communication facility which can be worn on the head, a headset for instance.

### BRIEF DESCRIPTION OF THE DRAWINGS

The invention is described in more detail with reference to the appended drawing, which shows a simplified block diagram of a hearing apparatus according to the invention.

### DETAILED DESCRIPTION OF THE INVENTION

The invention is described in more detail below with reference to an exemplary embodiment. In this embodiment, the FIGURE shows a hearing apparatus 1 according to the invention in a simplified block diagram. This features an audio signal input facility 2 for connection to an audio device. This is designed as a plug with a connecting cable for the purpose of a wired connection with the audio device for instance. The audio signal input facility 2 can however also comprise all components which are required for a wireless signal transmission to the hearing apparatus 1 (antenna or receiver coils, signal preamplifiers etc.). An audio signal incoming into the hearing apparatus 1 is processed in a signal processing facility 3, before being converted into an acoustic output signal by means of at least one loudspeaker 4 and being output. A control facility 5 controls the signal processing in the signal processing facility 3 by means of several control parameters which influence the signal processing. One set of control parameters is combined in a user profile, which significantly determines the signal processing in the hearing apparatus.

According to the invention, a number of user profiles are stored in the hearing apparatus 1, in the exemplary embodiment the two user profiles 6A and 6B, said user profiles 6A and 6B being able to be selected by actuating a control element of the operator controls 7 in order to individually determine the signal processing in the signal processing facility 3.

In the hearing apparatus 1 according to the invention, a hearing test device 8 is integrated in order to identify an individual hearing loss of a user and to generate control parameters in order to adjust the signal processing in the signal processing facility 3 to the individual hearing loss. The control parameters determined individually for each user on the basis of the hearing test form the basis of the different user profiles 6A, 6B. In order to implement the hearing test, a signal generator is integrated in the hearing test device 8, so that acoustic signals can be generated at different volumes and frequencies and can be emitted via the loudspeaker 4. It is thus possible to determine the hearing threshold and/or the discomfort threshold of acoustic signals for the respective user as a function of the signal frequency. The hearing apparatus 1 then automatically determines control parameters from this data in order to adjust the signal processing in the signal processing facility 3 to the respective hearing ability of the user. An audio signal, for instance a piece of music, is then presented to the user in this manner, with the weaknesses of the hearing ability of the user being significantly compensated for by means of the hearing apparatus.

Aside from the control parameters determined on the basis of hearing tests, certain user specifications are also advantageously suggested in the user profiles 6A, 6B, said user specifications not relating to the objective hearing ability, but instead to subjective perceptions. The user of the user profile 6A can thus provide an increase of high and low frequency ranges compared with the average frequency range for instance, which is not specified by its individual hearing ability. The hearing apparatus 1 according to the invention thereby enables the user to additionally account for individual preferences during the playback of audio signals in addition to compensating for an individual hearing weakness.

The hearing apparatus 1 according to the invention is preferably configured as headphones for connection to a plurality of current audio devices, e.g. electronic entertainment devices, hifi systems, television, PCs etc. To operate the hearing apparatus, elements such as a pushbutton 7A, a control element 7B or a rocker switch are present in the operator controls 7. A value of a control parameter changed by actuating a control element can thus be stored, at the request of the user, by actuating a further control element for instance, in a user profile assigned to the user, so that the adjustment of the signal processing in the hearing apparatus 1 effected by actuating the control element also comes into effect during each subsequent activation of this user profile. The changeover between different user profiles likewise takes place by actuating a control element in the operator controls 7.

The hearing apparatus 1 shown by way of example in the exemplary embodiment enables the two different user profiles 6A and 6B to be selected. A real hearing apparatus according to the invention preferably offers the possibility of storing and selecting considerably more than two user profiles. An individual user can naturally create, store and select a number of user profiles so that different user profiles can be selected as a function of the audio signal source or the audio signal, for instance a user profile for classical music and a user profile for rock music. In this way, a hearing apparatus according to the invention configured in a user-friendly manner thus allows at least the control parameters determined on the basis of hearing test to be directly transmitted from one first hearing profile to a second hearing profile, so that a hearing test need only be carried out once by each user.

1-8. (canceled)

9. An adjustable hearing apparatus, comprising:
an audio signal input device which receives an incoming audio signal;
a signal processing device which processes the incoming audio signal;
a loudspeaker which converts the processed audio signal into an acoustic output signal;
a storage device which stores:
a first user profile for a first user, and
a second user profile for a second user; and
a control device which adjusts the signal processing in the signal processing device according to the first or second user profile for the first or second user who is currently wearing the hearing apparatus.

10. The hearing apparatus as claimed in the claim 9, wherein the storage device stores a plurality of different user profiles for a plurality of different users and the control device adjusts the signal processing according to a user profile of a user who is currently wearing the hearing apparatus.

11. The hearing apparatus as claimed in the claim 10, further comprising a hearing test apparatus which identifies a hearing loss of the user and generates a control parameter to adjust the signal processing according to the hearing loss.

12. The hearing apparatus as claimed in claim 11, wherein the hearing test apparatus comprises a signal generator which generates an acoustic signal at different volumes and frequencies.

13. The hearing apparatus as claimed in claim 12, wherein a hearing threshold of the user is determined by the hearing test apparatus for the different signal frequencies.

14. The hearing apparatus as claimed in claim 12, wherein a discomfort threshold of the user is determined by the hearing test apparatus for the different signal frequencies.

15. The hearing apparatus as claimed in claim 11, further comprising an operating device which activates the control parameter stored in the user profile.

16. The hearing apparatus as claimed in claim 15, further comprising a display device which displays the current activated user profile.

17. The hearing apparatus as claimed in the claim 16, wherein the display device is selected from the group consisting of: a pointer attached to a rotary switch, an electronic numerical display, and a voice output.

18. The hearing apparatus as claimed in the claim 15, wherein the operating device comprises a control element for switching between the different user profiles.

19. The hearing apparatus as claimed in the claim 10, wherein the user profile comprises a user specification.

20. The hearing apparatus as claimed in the claim 19, wherein the user specification is a user preference which is inputted by the user and is independent of the hearing loss.

21. The hearing apparatus as claimed in the claim 9, wherein the hearing apparatus is a hearing aid device.

22. The hearing apparatus as claimed in the claim 9, wherein the hearing apparatus is a headset connected to an audio device.

23. A method for adjusting a hearing apparatus, comprising:
receiving an incoming audio signal;
processing the incoming audio signal;
converting the processed audio signal into an acoustic output signal;
storing a first user profile for a first user and a second user profile for a second user; and
adjusting the signal processing according to the first or second user profile for the first or second user who is currently wearing the hearing apparatus.

24. The method as claimed in claim 23, wherein a plurality of different user profiles for a plurality of different users are stored in the hearing apparatus and the signal processing is adjusted according to a user profile of a user who is currently wearing the hearing apparatus.

25. The method as claimed in claim 24, further comprising identifying a hearing loss of a user and generates a control parameter to adjust the signal processing according to the hearing loss.

26. The method as claimed in claim 24, further comprising switching between the different user profiles.
